(19) United States
(12) Patent Application Publication
(10) Pub. No.: US 2013/0346132 A1
(43) Pub. Date: Dec. 26, 2013

(54) DAILY ACTIVITY MONITORING

(71) Applicants: Eric C. Whitelaw, Edmonds, WA (US); David R. Taylor, Edmonds, WA (US)

(72) Inventors: Eric C. Whitelaw, Edmonds, WA (US); David R. Taylor, Edmonds, WA (US)

(21) Appl. No.: 13/913,268

(22) Filed: Jun. 7, 2013

Related U.S. Application Data
(60) Provisional application No. 61/656,661, filed on Jun. 7, 2012.

(51) Int. Cl. G06Q 10/06

(52) U.S. Cl. CPC G06Q 10/063114
USPC 705/7.15

(57) ABSTRACT

Method comprising determining a user set comprising at least one user entity, determining a manager set comprising at least one manager entity which corresponds to the user set, determining an income goal in a predetermined time period for each said user entity, determining a set of tasks, each task, when performed by an user entity, being worth a corresponding respective percentage of the income goal of said performing user entity, presenting a first user interface enabling an user entity to input one or more descriptions of performance by the user entity of a task, and presenting a second user interface configured to graphically illustrate to the manager entity information describing at least one of task performance by user entities and progress by each said user entity toward the income goal of each said user entity.

### PRIORITY CLAIM

This application claims priority to U.S. Provisional Patent Application No. 61/656,661 filed on Jun. 7, 2012.

### BACKGROUND OF THE INVENTION

Sales and the sales community function optimally when there is accountability for daily activities of sales agents within said community. The setting of income goals and the development of regimens of daily activity to achieve those goals are the universal staples of the sales world.

### BRIEF DESCRIPTION OF THE DRAWINGS

Preferred and alternative examples of the present invention are described in detail below with reference to the following drawings:

FIGS. 1-15 illustrate principles of at least one embodiment of the invention.

### DETAILED DESCRIPTION OF THE PREFERRED EMBODIMENT

Embodiments of the invention may be operational with numerous general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Embodiments of the invention may be described in the general context of computer-executable instructions, such as program modules, being executed by a computer and/or by computer-readable media on which such instructions or modules can be stored. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Embodiments of the invention may include or be implemented in a variety of computer readable media. Computer readable media can be any available media that can be accessed by a computer and includes both volatile and nonvolatile media, removable and non-removable media. By way of example, and not limitation, computer readable media may comprise computer storage media and communication media. Computer storage media include volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device, itself, according to an embodiment.

Correspondingly, it is to be understood that a computer-readable medium is transformed by storing software or computer-executable instructions thereon. Likewise, a processing device is transformed in the course of executing software or computer-executable instructions. Additionally, it is to be understood that a first set of data input to a processing device during, or otherwise in association with, the execution of software or computer-executable instructions by the processing device is transformed into a second set of data as a consequence of such execution. This second data set may subsequently be stored, displayed, or otherwise communicated. Such transformation, alluded to in each of the above examples, may be a consequence of, or otherwise involve, the physical alteration of portions of a computer-readable medium. Such transformation, alluded to in each of the above examples, may also be a consequence of, or otherwise involve, the physical alteration of, for example, the states of registers and/or counters associated with a processing device during execution of software or computer-executable instructions by the processing device.

As used herein, a process that is performed “automatically” may mean that the process is performed as a result of machine-executed instructions and does not, other than the establishment of user preferences, require manual effort.

### 1.1. Intent

One or more embodiments of the invention may be referred to herein as “PODs,” “the PODs application,” or the like. By allowing users to define their products, activities, and User (e.g., Agent, as used in an exemplary embodiment discussed hereinafter) success factors, an embodiment may allow organizations and individuals utilizing the PODs application to author income goals that dial down into specific and user selected activities, monitor and input those activities in real time, gauge activity success against goals and team, communicate and coach Agents in success strategies, more accurately gauge performance and time investment in activities, and to encourage a stronger sense of personal and team accountability for the many daily tasks that make up a sales person's process.

Viewed as a system of ‘Pods,’ each of which is a grouping of ‘Agents’ under a ‘Manager,’ all parties (note: all Managers may be Agents, each with their own profile, but all Agents are not necessarily Managers) are enabled to view the team performance as well as individual performance relative to the goals set and the results generated—with a special emphasis on the Manager's ability to see more deeply into each individual Agent and for the individual Agent to see their own progress/history to the finest detail. This team based system of accountability for activity tracking and performance may enable more efficient sales activity, be a value add to Managers and Agents alike and via an ability to aggregate a ‘Pod's’ performance/results into a Manager's own presented numbers (if said Manager is a member of another pod as an Agent himself) may allow the PODs system to represent organizations of great simplicity or great complexity as is needed by clientele.

### 1.2. Value Proposition

Different users may see different value in the PODs system:
Agents may enjoy the increased ability to project earnings.
Agents may enjoy the competitive framework of the Pods—creating a stronger sense of team.
Ability to organize, schedule and manage activities.
Agents may enjoy the improved coaching PODs enables Managers to provide.
Agents may enjoy the clarity which PODs gives to their activities results—enabling them to define more clearly what a wise investment of energy and time is.
Managers may enjoy the crystal clear picture of business operations that real-time PODs activity provides.
Managers may enjoy the ability to find the holes and weak spots in their sales organization with minimal effort.
Managers may enjoy a much improved ability to estimate and gauge activity.
Managers may enjoy the ability, once team data has been amassed, to leverage performance much more accurately from team members.
Managers may enjoy the ability to develop team members to be much more accountable with their activity leading to less waste and greater efficiency.
All may enjoy the added ability to have the team and the office with them no matter where business takes them.
All may enjoy the clarity of communication PODs enables by taking much of the ambiguity and guesswork out of assessing the sales process and individual performance.
All may enjoy the reduction in waste and the ability to focus in on achieving results—with each party able to do so as is reflective of their relative strengths or weaknesses.
Well defined, repeatable, intuitive goal setting and activity scheduling system.

### 1.3. Functionality

The functionality of an embodiment may include:

### 1.3.1. All Sales Activities May be Definable as Dollar Amounts

Because all sales activity fits somewhere within this expression, “commissions=revenues=sales=opportunities=contacts=leads=lead production,” a dollar amount can thus be attached to any and all sales activity. By creating an environment in which these attributes and value relationships are defined, an embodiment can enable Agents and Managers to define which amounts of activity are required to meet specific income goals.

### 1.3.2. All Activities are Traceable to Results

With all sales activities now tied directly to income goals and thus to revenue generation, what remains as unknown is the relationship of those anticipated results to reality and to a Manager's ability to inspect what is expected. By serving beyond goal setting, an embodiment may allow Agents and Managers to account for all activity by requiring daily input of results and achievement from each participant. This, when viewed across a team, allows Managers a never before seen view of team performance as tied to efforts and allows individual Agents an accountability to themselves and their commitments which has been previously left to each sales person's own responsibility.

1.3.3. All Participants Benefit from Group Accountability

Through the use of a shared view of activities, the system creates an ‘office’ environment that extends into the field—an embodiment does so by creating PODs. A Pod (defined more fully later), is a grouping of Agents under a Manager—their activity and results viewable to the team and the details of all work efforts viewable to the manager, ensuring the best possible chance of a Manager having a realistic view of his team's activity and the team the best possible chance of maintaining a realistic view of their progress.

1.4. Initial Launch vs. Universal Functionality

By way of example, in an embodiment, upon launch, the target Client of the PODs system is Farmers® Insurance. Our ability to succeed may be largely determined by our ability to speak to their particular style, language, systems, and needs. With that said, as an embodiment finds traction within Farmers® we want to be able to re-release with minimal modifications to a larger audience, new verticals, and different approaches to the business of sales.

An embodiment Product may thus include support for more than one Client and entry of those new clients may be executed directly into the database. Part of the entry of Client data may include entering terms and other data points that may be used by that Client.

To support new Clients when they are later added to the system, we support the following in the Product:
1. Naming of the hierarchical levels of Managers in the interface. For Farmers®, it's District Manager, Managing Agents, Agents. For a company like Mary Kay, there may be an infinite number of levels of Independent Business Owner.
2. The ability to name all of the Activities and Results.
3. The ability to name all of the Product Lines and Products.
4. The ability to configure new Security Codes to be used with the Client.
5. The ability to deploy graphics and configurations so that users logging into the Client's portal may see appropriate revision of the interface for the Client.

In the following section of core models you may find several items marked with notes on universal functionality vs. Product/Farmers® functionality.

### 2. Models

This section describes various models and functions in the system independent of the particular interfaces. Later in the document we may describe how users specifically interact.

### 2.1. PODs User Types

There may be several types of “users” of the PODs application according to an embodiment:

### 2.1.1. Visitors

Visitors are public users who do not have an account and who cannot log into the site—their holding page, the marketing site, is within the scope of development but may be extremely basic with optionally advantageously the login functionality, linking to the subscription functionality, and the static content of the marketing page, which may be provided by IPS fully rendered. When arriving at the site they are confronted by a welcoming page of some graphic sophistication that reveals very little about the site. Any and all attempts to enter the site may result in either a) their inputting of a password and login (redirect to one of the classes below) or b) their encountering of a contact page—encouraging them to enable an IPS team member to contact them regarding the PODs system.

The initial release may be aimed primarily at initial customers who have been sold via direct business development efforts.

However, there may be additional content that is part of a marketing site that may assist with marketing and sales efforts.

However, until such a time that the application is ready to re-release with a broader market approach in mind, the system may be available optionally advantageously by invite of IPS and or direct referral to IPS by members.

### 2.1.2. Agents

Agents are the primary user type. Agents are the sales people who are performing Activities in order to get Results.

### 2.1.3. Owned Agents (CSRs)

Owned Agents are an assistant to an Agent. Owned Agents perform activities on an Agent's behalf. Their activities and results reflect upwards to the Agent. When setting up a new user they may be established as being ‘Owned’. Owned Agents may not be able to:
Set Goals and Plans
Calendaring

### 2.1.4. Managers

Managers are Agents who manage other Agents and Owned Agents and who have access to a vast array of settings and increased permissions. They have all the same abilities as an Agent plus abilities not accessible to Agents. All of these additional abilities and permissions are accessed through the ‘Managers’ button from the navigation, including the Manager settings.

### 2.1.5. PODs Administrators

PODs Administrators (Admins) are IPS employees or contractors who are authorized to perform any and all administrative functions on the site.

### 2.2. Organization

There may be several relationship structures between Managers, Agents and Owned Agents.

The first and most basic is between Agents and Owned Agents. Owned Agents are owned by a single Agent.

The second is an N-tier management hierarchy. Managers own other users who themselves are Managers and/or Agents. Remember that every Manager is automatically also an Agent. The bottom tier of the hierarchy is users who are Agents only, i.e., they do not manage other Agents. They may own Owned Agents.

Some notes on this:

Everyone but the Owned Agent is an Agent in the system whether they want to use the Agent capability or not.

When a user is subscribed, they do so as a Manager or Agent (with no Manager capabilities). New users and existing users can input a Manager Code that establishes their direct manager. This places them in the management hierarchy.

### 2.3. Naming, Org Structure and Farmer's Terminology

The system is capable of supporting naming of levels of the hierarchy and particular roles. It may also be able to control the number of levels of hierarchy. The Product may be able to specifically support Farmers® but may provide core models for additional levels, naming that can be set in the database.

Farmers® may have three levels of hierarchy and may use specific terminology for each level:
District Manager
Managing Agent
Agent

As of the current design, there is no difference in functionality for a Managing Agent and a District Manager. In other words, for the Product, there is really no concept of a District Manager and the term is never used.

Additionally they have the following terminology:
CSR—is an Owned Agent

### 2.4. Pods

A Pod is a grouping of Users managed by a Manager. They are viewable as a team through a Pod page and that page works as a portal for the Manager to access his Pod's members' individual pages. The following basic rules should provide the overview necessary to further understanding of Pod use in the system.
1) Pods are not users. The Pod does not set goals and membership in a Pod does not affect goals an Agent may have. They are used for organizing Agents only.
2) A Pod can have as many members as a Manager wants.
3) Only Managers can create Pods, edit their membership, or change Pod settings.
4) Agents, via their Managers, can be in multiple Pods—if it benefits the manager to view them that way.
5) Pods are independent from the goal setting of Agents. Agents can view any Pod where they are a member. Membership is set by the Manager. Thus, each Agent may have a list of Pods that they can see with the exception of the special Pods (All Agents and All Owned Agents).

### 2.5. Value Models—Activities, Results, and Products:

One of the optionally advantageous concepts in the PODs system is having Agents set an income goal and then derive the Activities that may lead to achieving those goals.

### 2.5.1. Goals and Plans, Calendar, Actuals

One optionally advantageous aspect to all of this is that the system may track things at three levels:
Goals and Plans—these are the upfront Goals and Plans that are established by users. The
Goals are income goals. Plans are a set of monthly Activities that may be done in order to reach income goals.
Calendar—these are the Activities for a given month that have been specifically planned for that month. They correspond to Goals and Plans.
Actuals—these are the Activities and Results that have occurred during the month as reported by the user.

You can think of Goals and Plans as representing a template; Calendar as being the specific plan for a given month, and Actuals as the actual activities.

### 2.5.2. Results

The system may be capable of naming (via database settings) all Results items on a per Client basis.

For example:
Commission might be called Income by other clients
Revenue is called Premiums by Farmers®

### 2.5.2.1. Commission

Commissions are the resulting dollars to the Agent that comes from the sales. This is not shown to other users except the Agent and managers of the Agent.

The calculation of Commission is described below in the Products section.

### 2.5.2.2. Sale and Revenue

A Sale is a closed sale (customer transaction) recorded in the system. Revenue is the dollar amount that has resulted from the Sale. Revenue is shown to other users. At Farmers® these are known as Premiums. These are directly entered by the user based on a prompt that is part of the system on a Product Line/Product basis.

For example, at Farmers® Premiums may be entered for:
Whole Life—Monthly Premium
Commercial—Annual Premium

### 2.5.2.3. Opportunity

An Opportunity is a specific opportunity with a potential customer. It may be made up of one or more Products being suggested to the customer at a proposed amount. At Farmers® the product/amount is called a Quote.

As example Opportunity:
Customer Name: John Jones
Quote 1: Whole Life—$500
Quote 2: Auto—$300

### 2.5.3. Product and Product Type

Products are items that can be sold by an Agent.

Product Types are a given class of products. This can be thought of as a two level hierarchy:

Product Types contain
Products

Product Types have the following attributes:
Name

They are defined in the system on a per Client basis, but each Manager can change the list of Product Types and Products.

Farmers® may likely start with two Product Types (Product Lines):
Personal
Commercial

Products have the following Attributes:
Name
Product Type
Value String (string used to help user enter values for Commissions).
Multiplier
Commission Percentage (percentage multiplier to calculate Commission)

Farmers® may likely start with several Products including:
Auto—Personal—Six Month Premium, ×2 Multiplier, 10% Commission
Whole Life—Personal—Monthly Premium, ×12 Multiplier, 50% Commission

The Value String may be used to prompt the Agent. So for Auto, they may be prompted to enter the “Six Month Premium”. In response, they may enter the Sale Value for a particular Sale.

The system may take the Sale Value and multiple it by the Multiplier to arrive at the Total Sales Value for the Sale (Premium in Farmers® terminology).

The Commission for an Agent is the Total Sales Value multiplied by the Commission Percentage. For example, a whole life policy sold for a $100 monthly premium. The user may be prompted with “Monthly Premium” and would enter $100 (the Sales Value). The system would calculate the Total Sales Value as $100*12 (the Multiplier)=>$1,200. The system may calculate their Commission on this sale as $1,200*50%=>$600.

Agents may be able to see their Commissions. However, other users may only be able to see (in Pods) the Total Sales Value (Premiums).

When an Opportunity is created, the user may be prompted to create the associated Quotes. Each Quote may include a Product. When that Product is entered, the user may be prompted to enter the Premium and the system may use the prompt text to tell the user what value is expected. When a sale closes, and the user enters the final Premium, the system may use the Commission Percentage multiplied by the Premium to calculate the Commission earned by the Agent.

The Product may allow naming of Product and Product Type on a per Client basis via database settings. At Farmers®:
Product Type is called a Product Line
Products are called Policies

Product Types and Products may be setup in a baseline for a given client. However, the system may allow Managers to modify the list of products for themselves and everyone in their Management Hierarchy as a new baseline. Additionally, Agents can modify their Product Types and Products.

### 2.5.4. Activities

Activities are specific actions that a User can take (outside the system) in order to try to start to make sales. For example, they might make a call to someone from a particular list that might be referred to as “Hot List Calls.”

Each Activity may have the following attributes:
Product Line
Non-income Generating—a flag that indicates this activity does not generate income, therefore the number per opportunity is ignored. For example, some Retention activities might be considered non-income generating.
Number Per Opportunity
Minutes Per
Multiple

For example:
Hot List Calls; Personal; 10 per Opportunity; 2 minutes per; 1 multiplier
50 Doorknob Hangers; Personal; 2 per Opportunity; 12 minutes per; 50 multiplier

The Number per Opportunity represents how many on average may be required to complete in order to generate an Opportunity. This Number may be used along with some conversion percentages to calculate planned income.

The Multiple is used when the Activity has large numbers associated with it. For example, Doorknob hangers may be done in multiples of 50. So when the user records that they've done that activity, they are saying they have done 50 of them. This may make the interface cleaner in the system when recording large numbers of Activities.

Activities are initially setup for a Client. However, Managers at all levels can make changes to the list of possible Activities.

### 2.5.5. Commission and Conversion

Every Product Line may have the following attributes:
Average Opportunity
Conversion Rate
(calculated) Value per Opportunity

For example:
Personal —$120; 40%; $48
Commercial —$225; 40%; $90

The Average Opportunity represents what the average Commission may be from an Opportunity that closes. The Conversion Rate tells us how often we expect an Opportunity may close. The Value per Opportunity is calculated by the system and represents the value of each Opportunity of that Product Type for the user.

These values may be set up for a Client but can be modified by each Manager in the system.

### 3. Agent Functionality

### 3.1. Agent Universals

### 3.1.1. Color Codes

An embodiment may use Color Codes in the interface to signify completion status. The color code is a simple reflection of the percentage of goal completed—green may indicate 100% completion. Yellow (amber) for 66% or above. Red for below 66%. Final percentages (and color choices) may be set in the database to be used on a system wide basis.

For Color Codes on Weekly and Monthly numbers, the system may use completion-to-date to calculate. So, if we are on a day that is mid-week, then we may look at how many were planned to be completed to that point during the week, and how many were actually completed to that point to do the Color Code calculation.

### 3.1.2. Primary Navigation

Agents may be able to navigate to all of the functions within the interface.

Navigation may include:
Home
Stats
Activity/Results Entry
Coaching Forum
Pods/Pods View
Annual Planning
Monthly Calendaring
Owned Agents
Settings/Preferences

### 3.1.3. Pop-Up Reminders

There are special reminders that cause pop-ups to occur when the user comes to any page of the system and the reminder is required. An example is the Monthly Calendaring reminder. This may continue to appear to the user until they complete Calendaring.

These reminders are defined in the Notifications section.

### 3.2. Agent Home

The Agent Home page may contain:
Navigation that allows navigation to Home, Pods, Coaching, and other aspects.
Summary Data View—see below
Notifications Area—view of recent activity such as activities in Pods, Coaching Forum. These may link to the appropriate pages where details can be found. In the Product, this may not be real-time updated. In other words, the user must refresh the screen to see new updates come through.
Activity Entry—see below
Results Entry—see below

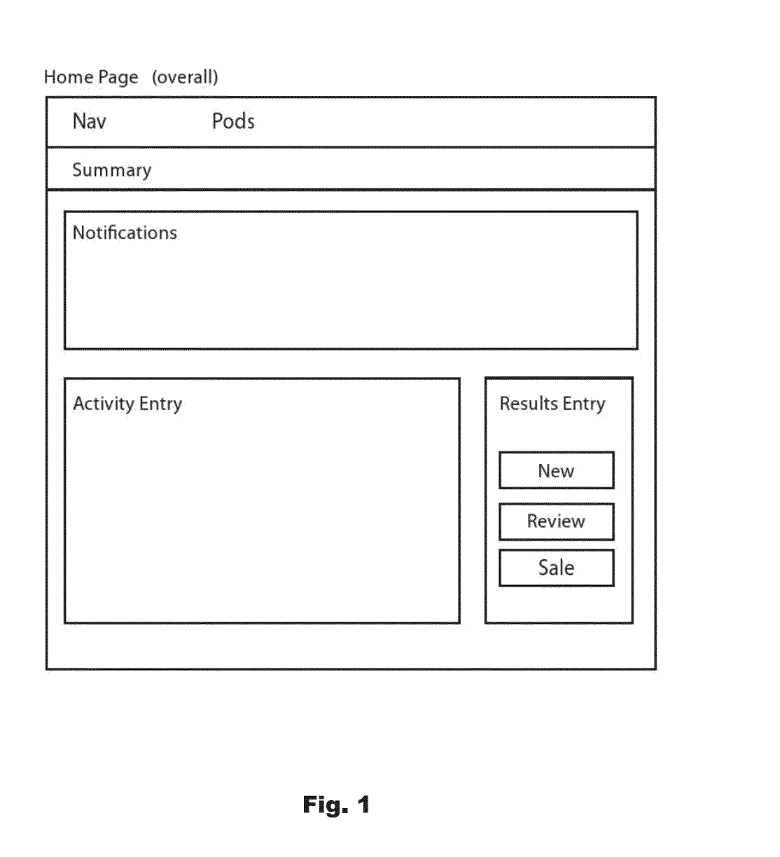

Conceptually, FIG. 1 depicts a home page.

### 3.3. Agent Summary Data View

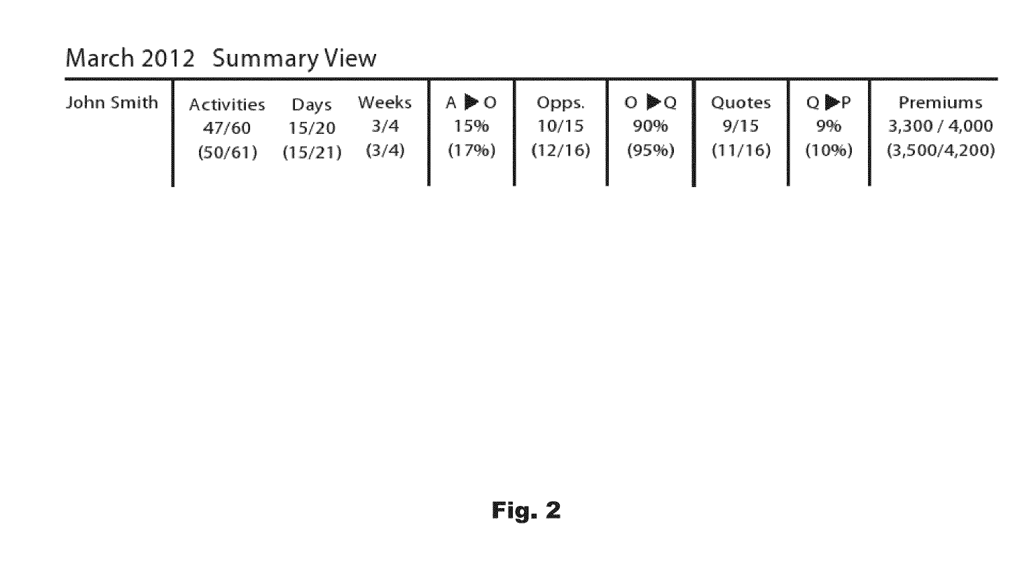

The Agent Summary Data View may be similar to the line items shown in the Manager's Agent Summary Report. This is conceptually shown in FIG. 2.

In addition to this information, the Agent may see:
Commissions
Income Goal

At a glance, the Agent may be able to see how they are doing this month and may be able to see similar information to what is shown in Pods about them.

### 3.4. Agent Detail Data View

The Agent Detail Data View may be similar to the Manager Agent Details Report—see that Section for Details.

Like the Manager, the Agent may be able to select a Time Period to show and a Comparison set (Time/Agents). They also may have the navigation via the Calendar control.

In an embodiment, unlike the Manager, Agents may not be able to choose other Agents to display.

### 3.5. Activity Entry

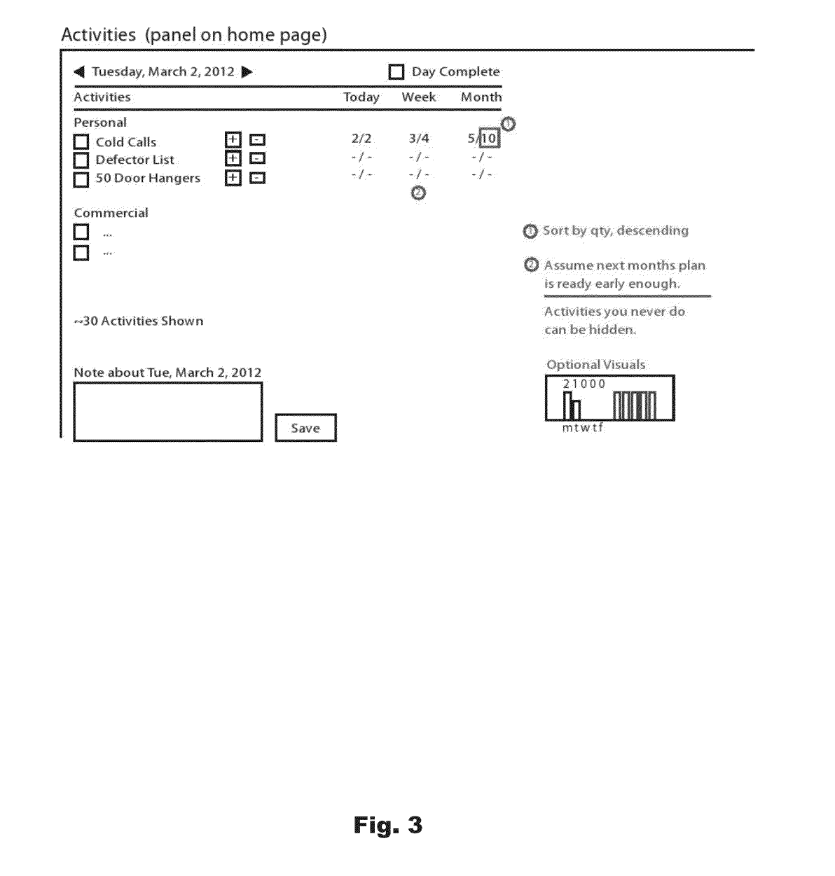

Activity Entry may be used to enter Activity information for the current date and look around at other days to see additional Activity plans. FIG. 3 depicts an Activity Entry.

The display may be for the current day, but the user can use the date control to navigate to other days. Details on what is seen for days other than the current day are described below.

Activities may be listed first according to product line and then based on the order that is the number planned for the month. For example, an Activity that has 100 planned for the month appears ahead of one that has 90 planned for the month.

Activities may be entered through a simple +/−. Clicking “+” may add one to the Activity Count for the day. A check mark may appear next to an Activity when all have been completed for the Day.

The display shows what is planned for the day. It may also have columns that show how an Agent is doing for the week and the month. It shows the current count to date and the total planned. It also Color Codes these values so that deficiencies on a week-to-date and month-to-date are indicated.

There is a graph next to each line item that shows the planned number for each activity for the current day and the following 6 days. As the user records activities, the current day in the graph may fill up. If a user works ahead (more than the number of activities), the graph may indicate completion of future planned activities.

For weeks that split a month, the week goal may show for the week including days that span the month. In other words, it may span both months.

If the user does not enter Activities before midnight on a particular day, then the user can no longer record Activities for that day. If there was a gap for the day, the system may always show the day as incomplete. The gap can be closed for the week by making up the activity, but gaps cannot be closed after the date. For example, if you fail to close the gap on the last day of the month, the week and month may always show a gap.

The Agent may be able to record a “Note” (small text entry) on a given day that explains what happened. The note can be viewed in the Agent Detail Report when you are looking at that day in the interface. Later versions may categorize those notes.

Activities that have no planned counts may be listed at the bottom. All entries may show on the Activity Entry screen unless they are specifically removed from the Activity Roster for this user.

When a user has entered Activities beyond their planned activity count for a given day, the system still records that the activity happened on the current day, but the extra activities are credited towards future plans. For example, if a user completes 3 activities on Tuesday and only needed to complete 2, then Tuesday may show 3/2 (assuming that the two required for that day are complete). And Wednesday, the next day may show one less required.

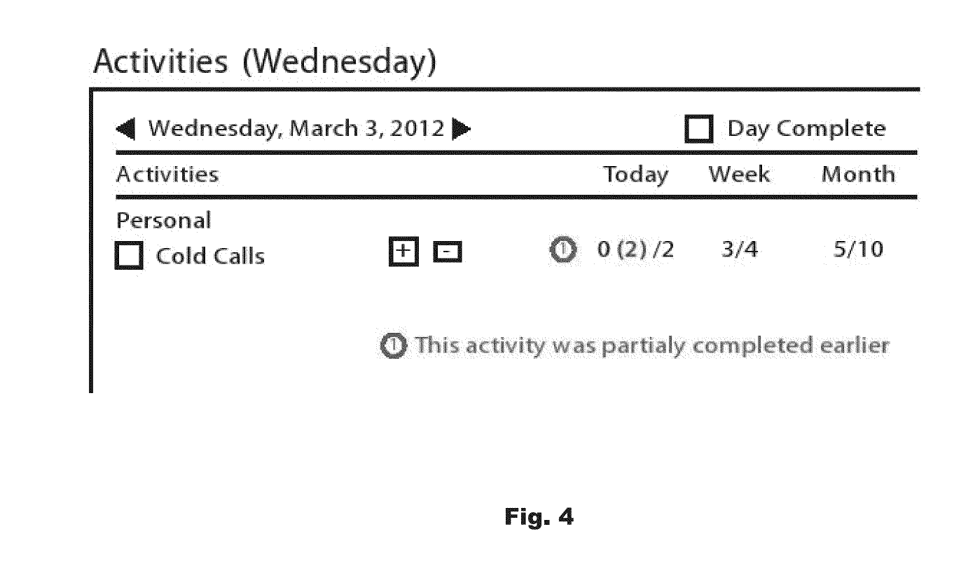

They may be able to see this reflected in the numbers and the graph. They may also see it reflected in the counts on days in the future. For example, the FIG. 4 shows a conceptual view of day where prior days had extra work done.

The system shows that while 0 have been completed for the Cold Call (CC) activity on this day, prior days have effectively produced 2 for this day and thus it is complete. Note: the visual should indicate a check mark next to CC to show that it is considered completed for the day.

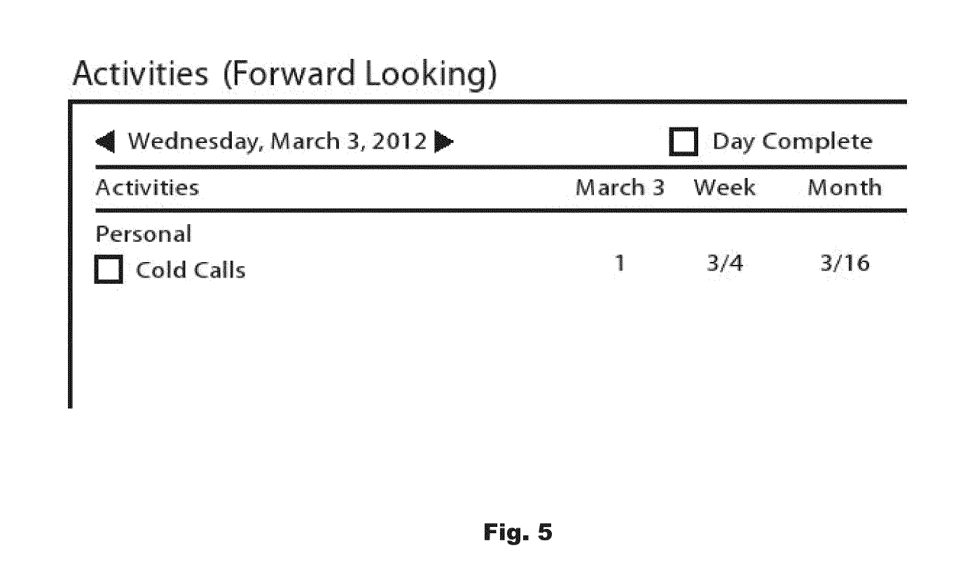

Activities may only be entered for the current day. If the user navigates to a future date, they may be able to see what is planned for that day, but may not be able to enter Activities via the +/− on that day. Activities may be always entered for the current date. This is illustrated in FIG. 5

### 3.6. Result Entry

On the Home Page, there may be easily accessible buttons that allow the user to enter New Opportunity, Record a Sale, and Review Opportunities. Each of these may result in access to the following functionality:

### 3.6.1. New Opportunity

The Agent may be asked to enter the following values:
Prospect/Opportunity Name, e.g., John Smith
List of Quotes
   Product (drop down list)
   Premium (dollar entry based on prompt for product)
Source Activity—Drop down list of Activities. They may choose the Activity that produced this Opportunity. They can also choose Other and then
   Other—text entry to say what the source was.

For each Quote in the New Opportunity, they may be given an increase in Quote Count for the month.

The system may offer some kind of virtual “pat on the back” (i.e., reward/award) when an opportunity is entered to the entering party.

### 3.6.2. Record a Sale

When the user chooses to Record a Sale, they may first choose from list of Opportunities that are Open or enter a Sale with no associated Opportunity.

User can enter a Sale that does not have an Opportunity associated. This may happen a lot as they first start to use the system. They get a Sale this month that did not result from an opportunity in the system. They can still tell the system the type of activity.

Whether they choose an existing Opportunity or Record a Sale with no Opportunity, they may have the ability to change the values associated with the Opportunity/Sale. This includes all of the information above in the Opportunity that includes the Name, Quotes, Source Activity.

The system may recalculate values based on this, but the Sale is considered to be final when they “Close” it.

As with the entry of a new Opportunity, the interface may be designed to give the user some kind of Good feeling—reward/award—something for closing the sale. Obviously the monthly income goes up.

### 3.6.3. Review Opportunities

This may bring up a list of existing Opportunities. From this list, the user may be able to:
Edit the Opportunity
Close a Sale
Record No Sale

The Agent can choose to view Opportunities that have been Sold or had No Sale by choosing an option in the interface.

Once a week the system may remind users to Review Opportunities. See Notifications for details.

### 3.7. Coaching Forum

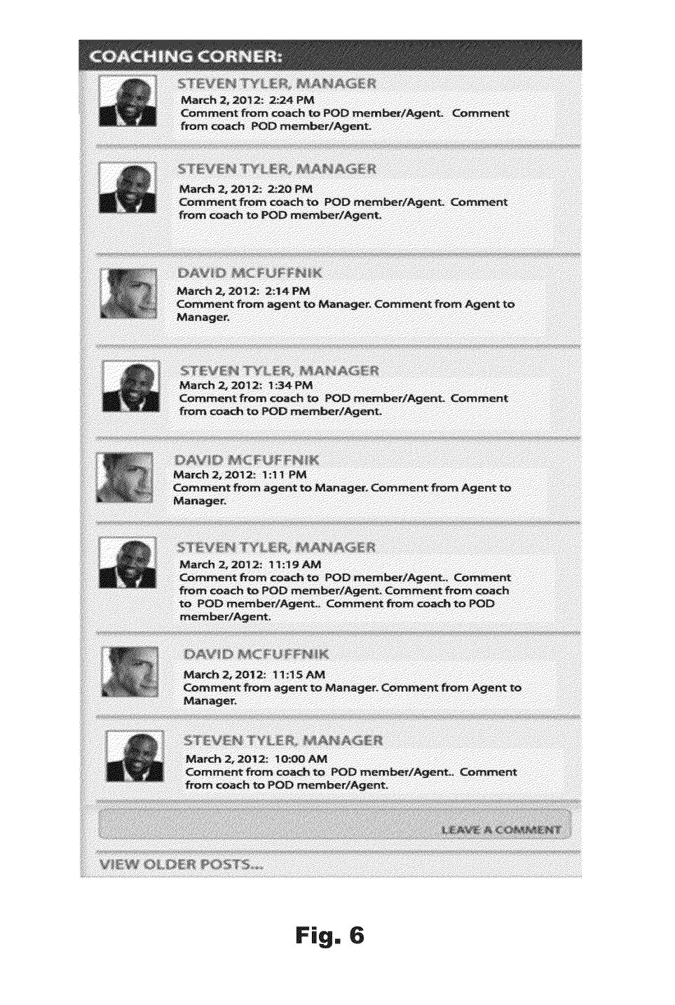

The coaching tool for one-on-one forum with their Manager. FIG. 6 represents it visually.

This tool functions as a ‘wall’—similar to a bulletin board. Each comment may include:
Photo
Name
Date
Time (not shown in graphic)
Comment (up to 170 characters)

New comments are entered via a field at the bottom.

New comments cause a notification email to be sent to the other users involved in this Forum. In the case of the coaching tool it's the Manager or the Agent.

Additional existing comments can be viewed by clicking View Older Posts. When used, it then scrolls down in the list and View Newer Posts and View Older Posts buttons appear top and bottom.

### 3.8. Daily Dashboard

The Daily Dashboard provides a small bit of wisdom to Agents probably located on their Home Page, but possibly on other pages as well. These bits of sales wisdom (text up to 400 characters with simple HTML formatting) may be supplied by IPS and entered into the system database. Quotes may rotate each day. In other words, one quote may be shown for the day to all agents across all clients.

### 3.9. Pods View

Agents may be placed into Pods by their Managers. Users may be able to use the navigation to get to view any of the Pods where they are a member. For now, we assume that this may be a list of Pods available to the user through the navigation.

There are two default Pods. All Agents (Managers Only) and All Owned Agents (Managers and Agents). These two Pods may not be visible to the Agents and to the Owned Agents. They may be only visible to the owning Manager.

Pods are represented by:
Name—set by the Manager
Owning Manager

Each Pod is a list of the Agents (or Owned Agents) and some basic data.
Their picture and name
Agency Name and Location
Number of CSRs—an integer value associated with each Agent that tells us how many CSRs work in the Agency.
Links to Email, Phone and Address
The main content for the Agent may be data for
   Premiums vs. Goal
   Quotes vs. Goal
   Opportunities vs. Goals
   Activity Completion vs. Goals

Users may be able to Sort Pods and see different information in lots of different ways.

By Time Period:
Today
This Week
This Month
This Quarter
This Year

This compares the data using To-date values. In other words, viewing This Week may show what has been completed to-date for the week. Note: an embodiment may use Monday—Sunday as the week in the application. These may be identical values to what is shown on the Agent Summary Report.

Sorting Factors—these can be changed by the user via interface controls:
Take into Account number of CSRs On/Off—when this is on, then divide Premiums
Rank by Total vs. Completion Percentage

Sort/Rank By:
Premiums
Quotes
Opportunities
Activity

All of the above criteria may be remembered on a per user/Pod basis so that it may be used again when the user returns to the Pod.

There is a special Pod for Owned Agents (CSRs) that exists for each Agent that has created at least one Owned Agent. This may show the information for all Owned Agents. Owned Agents are never placed in the same Pod as other Agents.

There may be a link next to each Owned Agent that may allow the Agent to bring up the Coaching Forum for that Owned Agent.

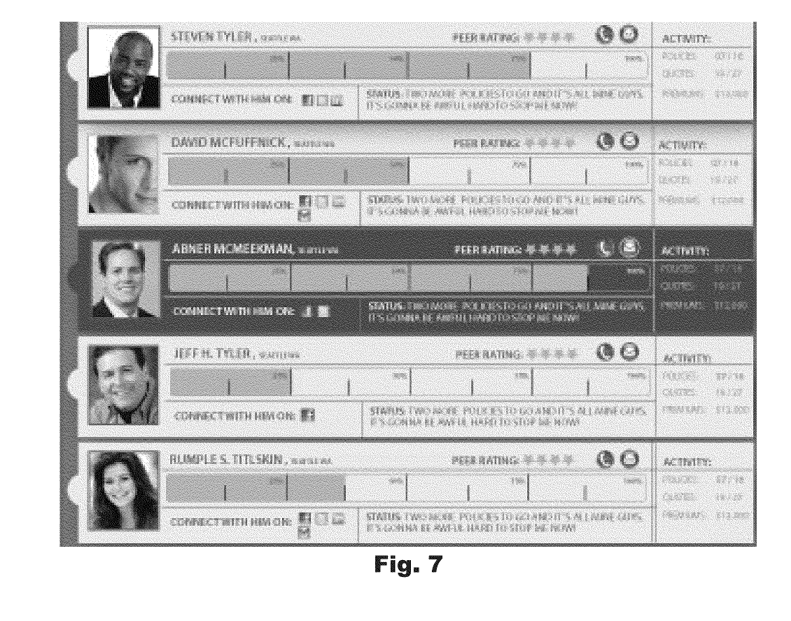

FIG. 7 illustrates an early comp for the Pod View.

### 3.9.1. Pod Forum

The Pod Forum is identical to the Coaching Forum except that comments can be made by the Manager of the Pod and all members of the Pod.

### 3.10. Annual Planning

The overall concept here is that Annual Goals and Plans represent a template for the income goals and activity plans for users that may occur on a monthly basis. It is expected that this may be done on an annual or semi-annual basis.

Each month, the Annual Goals and Plans may be used as the basis for planning the activities for that month as is shown below in Calendaring.

### 3.10.1. Step 0—Define Annual/Monthly Revenue Goal

The user may be instructed that the system is designed to help them achieve an annual income goal. We ask them to input an average monthly income goal. We may show on the screen what that translates into for an Annual income (×12).

The screen may also tell the user that monthly income may vary each month based on number of working days, but the system is designed to help them achieve their annual goal.

### 3.10.2. Step 1—Define Work Schedule and Working Days Per Month

Users may next be asked to help the system by telling us about days in which they may perform PODs Activities. The intent here is that users may tell us enough information that the system can determine the number of working days each year and the average number of working days each month. It may also find out about their general calendar.

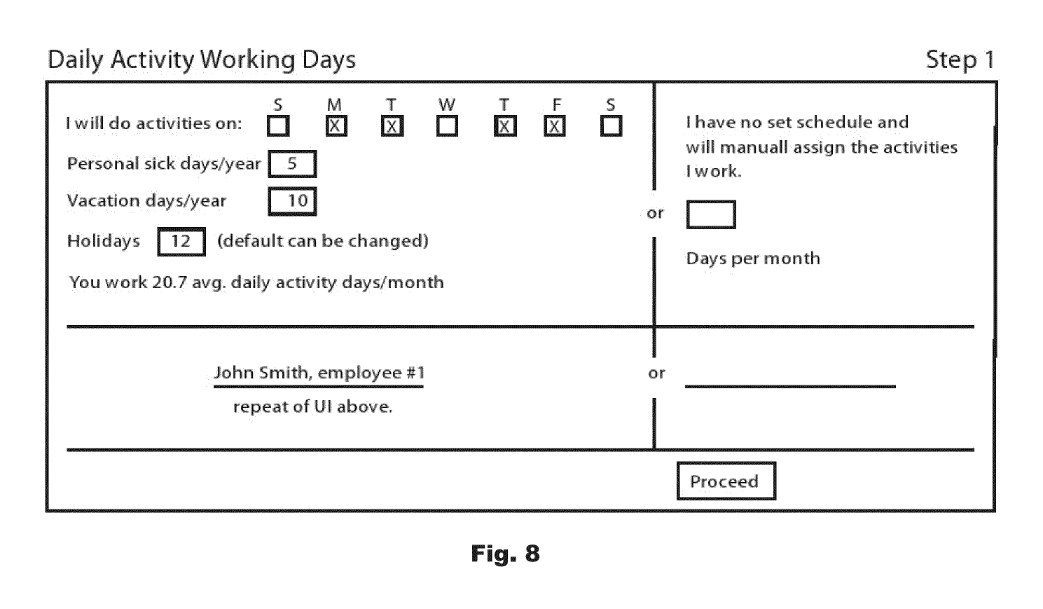

FIG. 8 represents a rough wireframe for this. The terminology for Personal and Vacation days may be changed slightly so that the system asks for the maximum number that they expect to take this coming year.

Agents may be able to enter either:
a. What days they may perform Daily Activities and other pertinent information, OR
b. providing a specific number of days per month. They may be strongly warned not to tell us the number of days per month unless they really do not have any kind of set schedule. If they choose this option, they may then be forced to manually calendar all activities.

The number of Holidays may be a system default based on the Client that can be changed by the user.

The average number of Daily Working days per month may be calculated and may change based on each input. It may be presented as a rounded number to one decimal place, i.e., 20.7 days per month.

This page may contain another set of inputs for each Owned Agent (OA).

A Proceed button may be available at the bottom of the long page.

### 3.10.3. Step 2—Define Activities

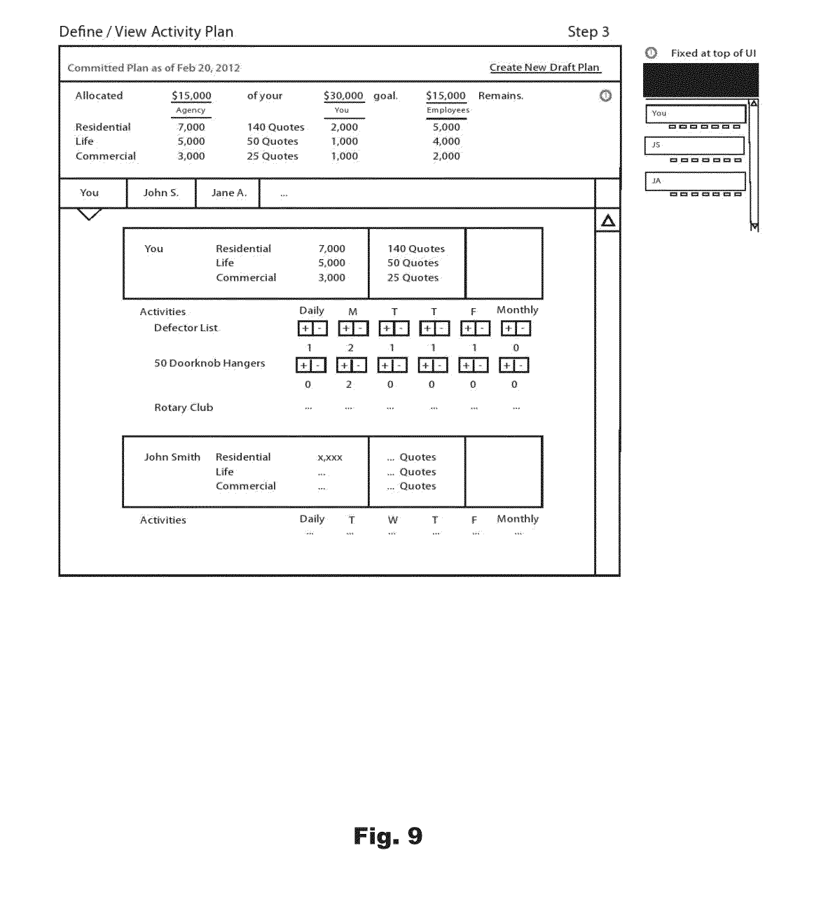

FIG. 9 represents a rough wireframe of this Step.

At the top, the user may see the status of the Activity Plan and may have different operations available based on the status. The Status may be:
Draft (New)—this is the first time and no Commit has been done to an Annual Plan
Committed—a Commit operation has occurred and no Draft has been created since that point
Draft (w/ Prior Committed Copy)—a Commit operation has occurred and the user is also working on a Draft plan that would modify the Committed plan.

A Commit is the way the user may indicate that they want to save and commit to the plan.

A Draft represents a new Annual Plan. It may be worked on and stored in the database as changes are made until the user chooses either:
Commit Plan—saves the plan over the prior Committed Plan and it becomes the Plan going forward starting with the next calendar month.
Delete Plan—deletes the Draft Plan

At the top of this page, the system may tell the user and provide the following operations:
You are working on a Draft Plan: Commit or Delete. —OR—
You have a Committed Plan as of <date>. Create New Draft Plan.

When the user commits a plan, their manager (if there is one) may be notified that a new Plan has been Committed.

Immediately below the top region, there may be an area that shows the Revenue Goal on a monthly basis, how much of that goal has been met so far based on Planned Activities, and the gap between Planned and Goal.

It shows the numbers broken down for the Agency as a whole, for you and for Owned Agents (CSRs) broken down by Product Line.

The system shows revenue goal including product line goals and has places that show how much your Activities may contribute to those as well as the current gap.

The conceptual wireframe may need to be corrected such that there are only two Product Lines: Personal and Commercial.

Below the goals area of the screen, there may be a region that allows you to quickly jump to yourself or any of your Owned Agents (CSRs) in the bottom scrollable area.

The bottom scrollable area may be a big region that has one area for your plans and the one for each Owned Agent. For each of these people, it may show planned Revenue and Quotes based on Activities.

Below that it may have one line for each Activity. The user can choose to enter +/− next to any of the items:

Each activity may have a choice of:
Daily—this adds one to each of the planned working days for that person. In other words, clicking + next to a Daily for Defector List would add one to M, Tu, Th, F—the working days for You.
Working Days—a +/− on a particular working day just adds one to that day. This would allow you to say that you plan to do 2 on Tu and 4 on Thu.
Manual/Monthly—a +/− on this just adds to this number. You may need to manually schedule these things each month.

Each update to Activities may result in appropriate, dynamic updates everywhere on the screen. Specifically, it may change your expected number of quotes, income on a product line basis, and overall income at the top of the page.

All of this is based on a simple formula using average number of days per month * value of each activity.

The bottom section continues down the scrollable region where you can assign Activities to OAs (CSRs).

Owned Agents do not have specific Revenue Goals. Instead their Goals may come bottoms-up based on Activity Plans. In other words, there may be planned Revenue based on their Planned Activities.

Everything that is not assigned to an OA is by default a Goal or Plan assigned to yourself as an Agent. It starts this step with all Goals coming from the Agent, but it begins to spread out based on Activities being assigned to OAs.

### 3.11. Monthly Calendaring

This is done each month where the Goals and Plans feed into the specific calendar of activities for that month. The first time, this is done as part of a larger process that represents the fourth step in the process described above. However, the user may be prompted to move to this activity. It may not necessarily show them this as the next step. After the first time, this is done towards the end of each prior month. There are special notifications and prompts to remind users that they need to complete their Monthly Calendaring for the following month. See Notifications for details.

Users who are doing this for the first time may be prompted by the system that doing this mid-month may cause their first month to be a bit weird. The number of working days may be calculated based on the current date and numbers may be lower because of that.

The system may automatically populate each month with the appropriate values based on the current Annual Plan when the user firsts visits that month for Planning Once they have modified that month, committing a new Annual Plan may not affect the plan for the month.

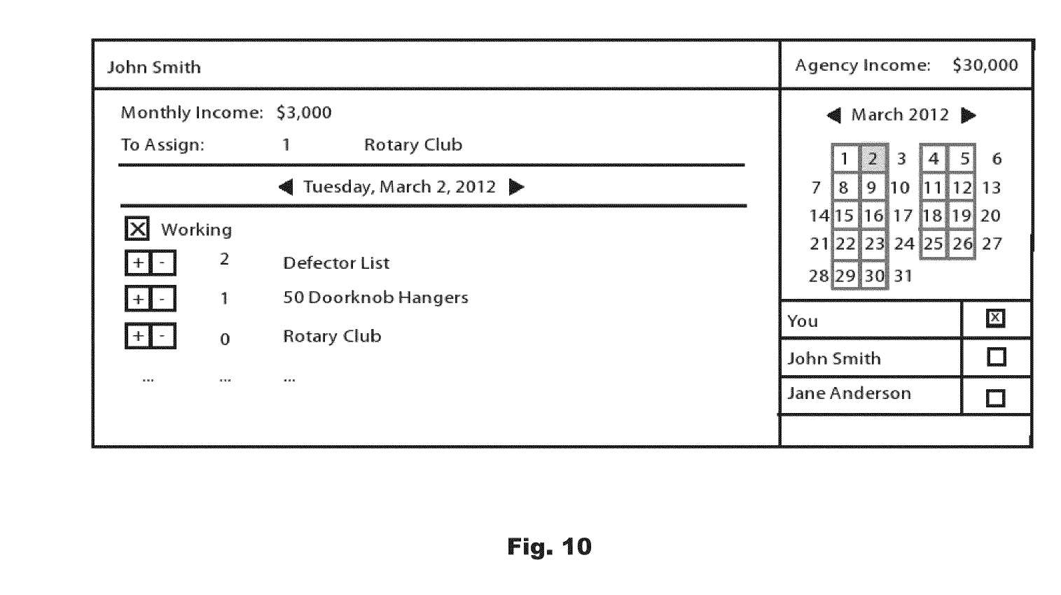

FIG. 10 represents a rough wireframe of the Monthly Calendaring interface.

The left column of the interface contains information about the currently selected person with the default being You as an Agent. This column contains:
The name of the person that is currently being planned.
A commit button (Not shown) that saves the plan for the month and checks off that person in the right column.
The income goal pro-rated for the month based on working days.
A list of Monthly/Manual Activities yet to be assigned to a particular day, e.g., Rotary Club meeting.
The currently selected Day.
A check box that can mark that day as working or not working If the user changes a day to be a working day, Daily Activities may automatically be added to that day. If the user changes it to a non-working Day, all Activities may be removed from that day.
A list of Activities for that Day with the ability to +/− those activities.

The right column of the interface contains:
Agency Income Goal—this is pro-rated based on working days that particular month
Mini-Calendar—this shows the working days that month for the currently selected person. It may visually indicate both of the following:
   Working/Not Working Days
   Days with Modifications from the baseline plan, i.e., you've done some +/− on those days.
You and all of your OAs (CSRs). You can select a person to begin to work on their calendar. This also shows whether the person has been reviewed and committed in the left column.

This interface may be available to the user at any time in the system. Values may only be changed for days later than today. It may change those days and the overall plan for the month.

Values shown for income and required Monthly/Manual activities may be updated appropriately based on input of Activities for the month.

For activities that have large counts, e.g., Doorknob hangers. The activity may be “Hang 50 Doorknob Hangers”. The system may have a setting that is an integer representing how much that activity goes up with each +. In this case, each + indicates 50 being done. 4 of them indicates 200 may need to be done.

When an OAs plan is committed, the OA may be notified via email of an updated/committed plan.

### 3.11.1. Forced Calendaring

On the first day of the month, if the user has not completed their Monthly Calendaring for themselves and all of their Owned Agents, they may be forced to go into that part of the application and complete it before they can move on in the system. At a minimum, the user may need to hit Commit next to themselves and each Owned Agent in order to accept the default Activities for the month.

### 3.12. Owned Agent Reports

At any time, the Agent may be able to see Reports for their Owned Agents (CSRs) that are the same as what is available to Managers (see below).

### 3.13. Agent Settings

The following are Settings the Agent can make in the system.

### 3.13.1. User Data

They can see/edit the same set of information they entered at sign-up:
Email
Phone
Address
Agency Name
Number of CSRs
Photo

### 3.13.2. Create/Edit/Delete Owned Agents

Agents may be able to Create/Edit/Delete Owned Agents. The information here is the same as in the creation of Owned Agents during Subscription.

### 3.13.3. Manager

Users may be able to change/add a Manager by entering the Manager Code. This may place that Agent under the Manager. This may occur when a user has signed up and subscribed, and later the Manager above that Agent signs up.

### 3.13.4. Preferences

Users may be able to set:
Landing Page—Managers may be able to set their preference for a landing page to either have the Agent View or Manager view.
Notifications—Agents may select which events may cause notifications to be sent to them. See the Notifications Section below for details.

### 3.14. Help

This is where Agents can find a basic help guide provided by IPS to answer user questions. In the Product, this is a static page that can be loaded via the database on a per client basis. Later, as our knowledge of user needs and issues grows we may evolve a more comprehensive help product to assist users with managing their process.

### 4. Owned Agent Functionality

Owned Agents have a similar interface and functionality as Agents. They are able to:
Enter Activities and Results
See their Calendar, but cannot modify planned Activities.
Coaching Tool with their owning Agent.
Set limited Preferences that are appropriate to Owned Agents. They may not be able to change their notification preferences for reminders that Activities need to be completed for the day. This may be controlled by the owning Agent.
View the Owned Agent Pods (may not be able to view other Pods)

They may not have access to:
Set Goals and Plans
Perform Calendaring

### 5. Manager Functionality

### 5.1. Manager Home

The Manager Home may include a list of recent notifications such as subordinates completion actions, forum posts, etc. Each of these may link to pages in the interface.

The remaining Manager Home page may be quick links to Pods and Reports.

### 5.2. Create/Delete Agents—

In an embodiment, the Manager may not be able to create/delete Agents under them. Instead, they must subscribe and provide the Manager code. Invitations may be done outside the system.

Instead, the Manager may be able to see lists of Agents and Owned Agents at any time, report on those agents, etc.

### 5.3. Pods

Managers' views of a Pod is identical to Agents except:
They may have an Edit button that may allow them to make edits to membership and attributes (Pod Name).
They may be able to open the Coaching Forum for the Agent.
Each Agent name may navigate to the Agent Detail Report

Managers can create new Pods, modify Pods and delete Pods with the exception of the default Pods for All Agents and All Owned Agents.

When the Manager creates a new Pod, they simply need to enter a name for the Pod, choose whether it is for Owned Agents or Agents, and whether the Forum may be active. Then they may be presented with a view that has all Agents (or Owned Agents) listed and check marks to control whether the Agent may be a member of the Pod.

When an Agent/Owned Agent is added or removed from a Pod, they may receive a notification.

Editing the Pod uses the same interface. There may be a button for deleting the pod with a confirmation.

### 5.4. Reporting

Reporting is a capability that Managers have to accomplish two important tasks:
1. Perform a quick scan of Agents to see who is having issues. They may be looking for symptoms such as:
   a. Missing completion of Activities on particular days
   b. Under delivering Activities for month
   c. Problems with Conversion numbers—Results
2. Drill down on a specific Agent to see how they are doing and what issues they have. May need:
   a. View of days, weeks and month to get sense of how they are doing on Activities
   b. Drill down on particular days to see what they accomplished that day including seeing notes.

On the Reporting page, the Manager may be able to choose:
Time Period—Week, Month, Quarter, Year or past Time Period (Week, Month, Quarter, Year)
Comparison—A Pod or Prior Time Period

The Time Periods are all to date, i.e., Week-to-Date, Month-to-Date, etc.

If they choose a past time period, they may get the entire period chosen (Week, Month, Quarter, Year).

The Comparison allows them to choose what data to use for comparison (if any). If they choose a Pod (that includes the All Agents Pod), they may see comparison that is the average of that group. When Managers are viewing reports for Owned Agents, they may only be able to use Owned Agent related Pods.

When viewing a Comparison Time Period and viewing a to-Date report, they may see the data for the same number of days in the prior Time Period. I.e., if you are 45 days into the quarter, you may see a comparison with the numbers for the first 45 days of the prior quarter.

### 5.4.1. Agent Summary Report

There are two Agent Summary report views that the Manager can select.

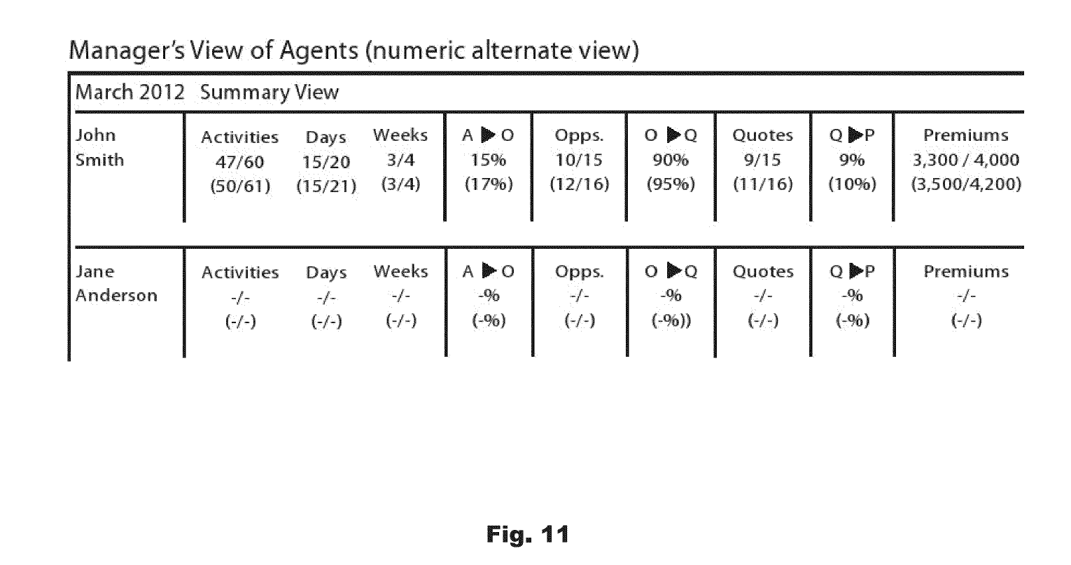

As illustrated in FIG. 11, the Manager may first select a given Pod (that can include All Agents and All Owned Agents). The Manager may also be able to choose Time Period and a Comparison set.

This chart may have one row per Agent (could be all Agents under this Manager or a given Pod).

Each row may have:
Agent Name—this may be a link to the Agent Detail Report
Activities
   Number vs. Goal and below it a comparison based on whatever the comparison is. For example, this might be comparing versus last month or against other agents. Note the screen may need to show this. It also might include another line that is the percentage difference (better or worse) than the comparison group.
   Days/Weeks fully completed
   Conversion percentage of Activities to Opportunities
   Opportunity numbers
   Ratio of Opportunities to Quotes (this would be a number like 1.5—different from example shown in screen above)
   Quote numbers
   Quote to Premium conversion
   Premium numbers

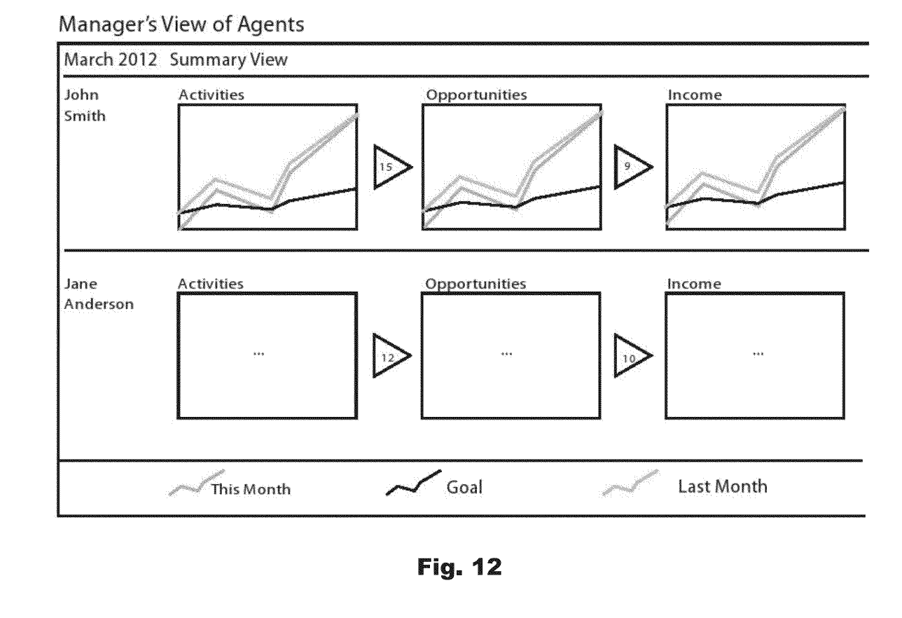

There is an alternate view of the data that uses charts. The Manager may be able to select the view in the interface. FIG. 12 shows that view.

This chart shows basically the same information, but visually. It shows:
Activities Completed vs. Goal vs. Comparison
Conversion ratio
Opportunities completed vs. Goal vs. Comparison
Conversion
Income vs. Goal vs. Comparison

It would repeat for each Agent.

### 5.4.2. Agent Detail Report

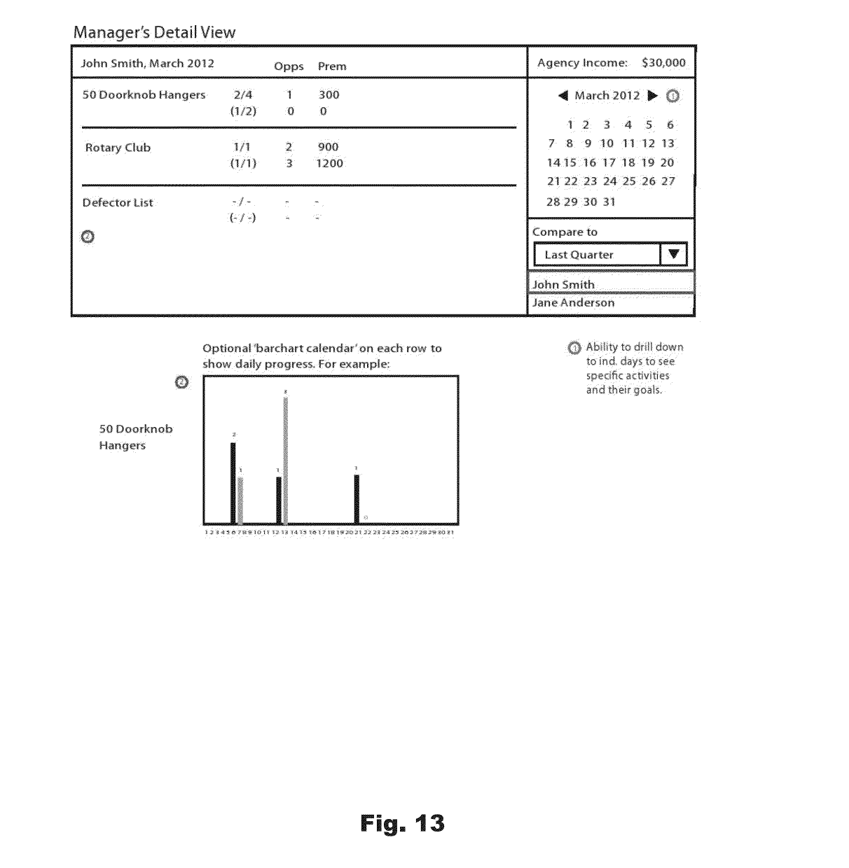

As illustrated in FIG. 13, this report is for a specific Agent Activity. It uses a similar visual as is done in Calendaring. You can choose the particular Agent via the right side navigation.

You can see Activities over the given time period and in comparison to the comparison set. You can also drill down to particular days to see activities on that day.

Selection of Time Period and Comparison may be the same as for the Agent Summary Report.

The weekly or monthly view depicted as a chart on the lower left may appear next to each activity may show progress.

While not represented, the report may include Conversion Ratios (and comparison) as is shown in the Agent Summary Report.

### 5.5. Preferences

Managers may have preferences that are the same as Agent preferences as described above. They may have additional notification settings available because they are a Manager—see Notifications.

Managers are able to see:
Manager Code—used to set up manager relationships
Client Code—used during registration

### 5.6. Settings for Product, Activity, Results

Each Client may have a set of baseline information created for them as may be described in each section below. When a Manager is first created with no Manager above them, e.g., a DM in Farmers®, the Client values may be copies for that Manager and can be modified by the Manager. These modifications may affect that Manager and all of their subordinates. When a Manager is created that has a Manager, they may get a copy of their Manager's current set of values. Similarly, when Agents and Owned Agents are created, a copy is made of their Manager's information. They can then be modified.

For the Product, these are all copies. If a Manager adds a new Activity to their Activity Roster, their subordinate Agents may be notified. However, they may not get a copy of the Activity. Later versions may include the option for Managers to add that to all subordinates.

### 5.6.1. Products

The Product Roster is the set of Product Types and Products that exist in the system as described above (Section 2.5.3).

Managers can add/edit/delete Product Types and Products for themselves. They may also be shown a list of all of their Agents and Owned Agents and may be able to add/edit/delete for each of them.

### 5.6.2. Activities

The Activity Roster is the set of Activities. See the attributes of Activities described in Section 2.5.4.

Managers can add/edit/delete Activities. Activities that have been removed for an Agent may not appear on the Activity Entry screen. Otherwise, all Activities appear there even if they have no planned Activities. It may be up to the Manager to remove them for the Agent.

They may also be shown a list of all of their Agents and Owned Agents and may be able to add/edit/delete for each of them.

By editing on a per-Agent basis, the Manager may be able to set up different expected conversion rates for different Agents.

### 6. Common Page Elements

### 6.1. User/Login Block

The login block may exist in the top right area of the interface at all times.

Prior to login, it may have inputs for email and password as well as a “forgot password” link. This allows users to enter their email address to retrieve their password.

Login follows standard interaction patterns. It allows users to enter their email and password and hit the <enter> key or click “login” to log in.

Hitting enter in the email when the password field is empty changes focus to the password field. Hitting enter while in the password field while the user name is empty changes focus to the email field. Hitting enter when both fields have values, causes Submission. Submission can also be done by clicking the “login” button. Upon Submission the email and password are verified. The email and password are case sensitive and must match exactly.

Successful login may take a user to 1 of 2 places:
Registered users may go to the previously completed step in the Registration Sequence described in section 5.
Members may go to their Agent home page.

Errors may be reported on a separate page (Login Page).

The system may have an idle session timer that logs a user off automatically after an amount of time set in the database where the user has had no activity (initially 120 minutes). When the user attempts to navigate after their session has timed out, if they have chosen to remember their password on the computer, then they may be able to log back in automatically and continue. If they do not have their password remembered on the computer, they may be taken to the login page with a message that they have been logged out because of inactivity.

### 6.2. Footer

Footer may be comprised of standard copyright data and links to static pages: contact, policies, FAQ, business inquiries, and about.

### 6.3. Contact Us Form

The Contact Us link may bring up a Contact Form page. This may include entries for:
Reason: <drop down includes Make Suggestion, Need Help, etc.>
Name <filled in for logged in users>
Email <filled in for logged in users>
Text Entry

This may result in an email being sent to a given email address with all of the information including when it was submitted. It may also store this in the database for later evaluation.

### 6.4. Error Message Handling

All pages that contain input fields may have an error area on the page that allows an error to be reported by the system on the page. Errors may result in showing the same page again with the error.

Errors may often contain specific information about the error in order to direct the user. For example, “State must be selected. Please select and submit.”

### 7. Marketing Site—Home Page and Static Pages

The home page and static pages may be implemented by the development team based on designs to be submitted by IPS, the scope of which may be a landing page with login functionality (the gate to the application) and redirects to contact IPS/purchase a subscription. For our Product our landing page may fit the PODs aesthetic but be functionally minimal, built to match the product output styles and structures.

### 8. Subscription, Registration and Owned Agent Setup

For the Product, IPS may take a hands-on approach getting users going in the system. The system may need to support technical setup, subscriptions, etc.

The system may also support having them go through the Product Lines, Products, Activities. Again, they may be helped through all of this.

### 8.1. Step 1—Client Security Code

Every Client may have a Client Security Code. For signing up, you must enter this first when you start the subscription/registration process. If they do not have one, it may indicate they should contact IPS about access to a code.

### 8.2. Step 2—Subscription and Manager Codes

Then the system may ask for:
Subscription Code—IPS may be able to enter these manually into the database along with the user information in order to provide users with access without paying. This is an optional value. If a code is not provided by the user, they may be asked for payment information.
Manager Code—It may ask whether your Manager provided you with a Manager Code. Again this is an optional value. If none is entered, the system may assume this user is a top most manager.

The system may validate these codes against the database and provide error message.

If they provide a matching subscription code, the user skips the next steps because the subscription and payments are set.

### 8.3. Step 3—Subscription Type

All users may be asked for what Subscription Type they want according to the list below.

### 8.3.1. Manager w/5 or More Agents

This may correspond to District Managers or very large Agencies. This may be a $150/month subscription.

8.3.2. Managing Agent w/ less than 5 Agents

These are ALL Managers who are not DMs and who have their own goals/income settings, but who DO manage people—CSR class or Agent class. These Managers pay $100/mo.

### 8.3.3. Agent

All individuals who use the system to chart their activity, but who do not manage other Agents. They can have an unlimited number Owned Agents. This may be a $50 subscription, for example.

8.4. Step 5—Enter basic information about user

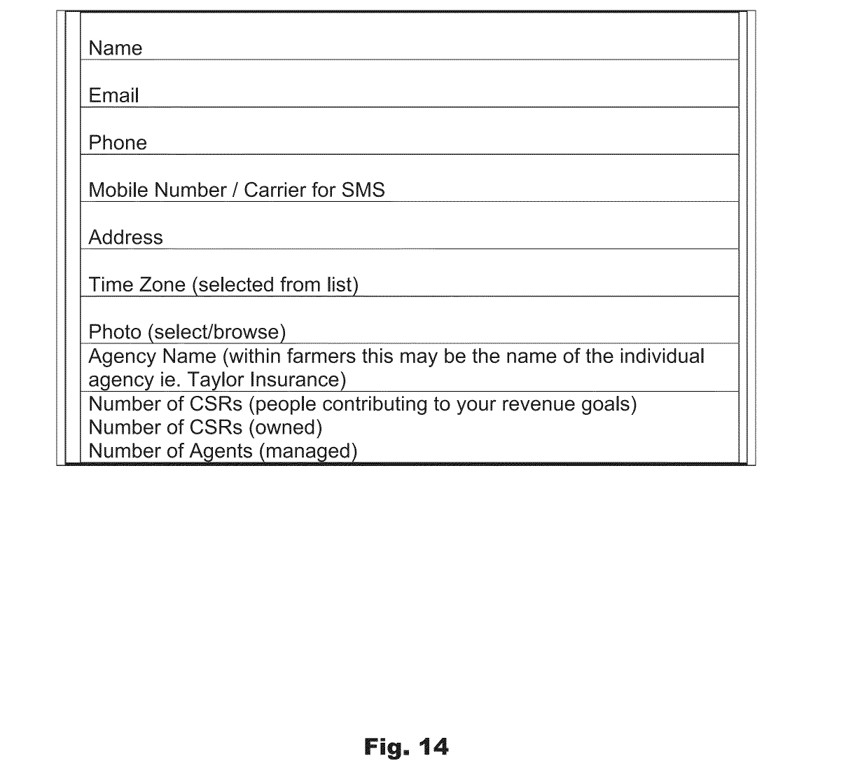

As illustrated in FIG. 14, they may be asked to enter the following information:
Name
Email
Phone
Mobile Number/Carrier for SMS
Address
Time Zone (selected from list)
Photo (select/browse)
Agency Name (within Farmers® this may be the name of the individual agency i.e. Taylor Insurance)
Number of CSRs (people contributing to your revenue goals)
Number of CSRs (owned)
Number of Agents (managed)

The Number of CSRs is asked independent of the number of Owned Agents (CSRs) because that count may be different if the user does not enter information about each Owned Agent.

Photos may use a simple upload process and may be restricted to a limited set of input types and file sizes.

After finishing the information request they are welcomed to the system and an email is sent to their email address. The user is told to find it and look for it in spam filters. However, roundtrip is not required to validate the email address.

### 8.5. Step 6—Setup Owned Agents

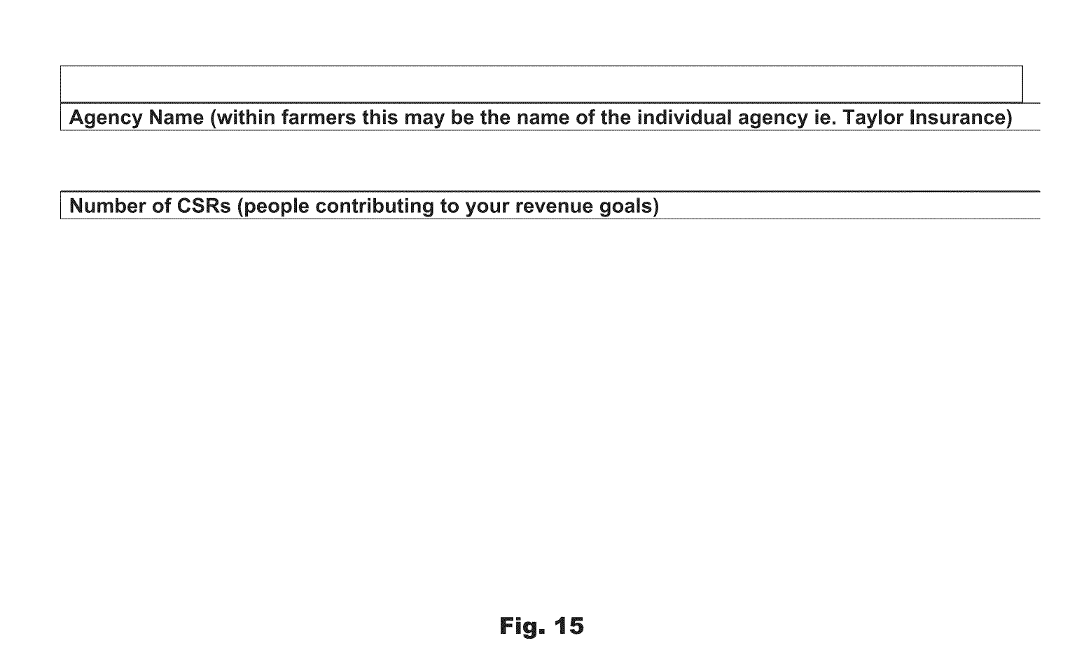

User is able to go through and setup each Owned Agent. As illustrated in FIG. 15, this consists of entering the same data as was entered above for a user except they may not re-enter:
Agency Name (within Farmers® this may be the name of the individual agency i.e. Taylor Insurance)
Number of CSRs (people contributing to your revenue goals)

The Owned Agent may be sent a welcome email from the system.

### 9. Mobile Functionality

The mobile functionality may be a very much reduced version of the application implemented as a web interface (HTML5) that is designed to work at a lower resolution and has lighter weight pages. The site may be designed for a limited width resolution that may accommodate scroll bars.

The site may recognize mobile users using standard techniques and may bring those users to the mobile version of the application. There may be an option to run the full version of the application from all screens in the mobile version. There may also be a link in the footer of the full version to go to the mobile version.

### 9.1. Login

After recognizing the device as a mobile device, the user may be taken to a login page. At that page, they may provide their email and password. If the user has a prior cookie, they can bypass and go directly to the mobile pages.

### 9.2. Agent Mobile Pages

The Agent may have a very simply navigation bar that allows them to change between the following pages.

### 9.2.1. Activity Entry

This may be a slightly reduced version of the Activity Entry from the web site. It may not contain the graphs. It may contain all other information. The size of the + button may be increased as may other text elements for better reading.

### 9.2.2. Results Entry

The interface may allow the user to enter Results the same as they can in the web interface.

### 9.2.3. Agent Detail Report

The interface may provide a reduced view of the Agent Detail Report.

### 9.2.4. Pod List

The interface may allow selection of a Pod from a list of Pods.

### 9.2.5. Pod View

This may be a different layout of the same information in the web interface for the Pod View.

### 9.3. Manager Pages

The Manager may have the same pages available as an Agent. However, from the Pod View, they may be able to navigate to the Agent Detail Report for that Agent.

### 9.4. Owned Agent Pages

They may have the same Pages as an Agent interface.

### 10. Notifications

The system may send email notifications to the user based on particular events in the system or periodically.

For each notification, the user can select the following options in Preferences:
No notification
Immediate notification via email
Immediate notification via SMS
Include in Daily Summary email

They may still see some of these kinds of notifications on the Home Page.

The Daily Summary may include all notifications that have accumulated during that day.

SMS notifications may be sent via email. The user may be asked for their SMS-routing email address and may be provided tips for common carriers, e.g., 3107146274@mobile.att.net.

The following is an exemplary list of notifications:
Product Roster has been changed by your Manager.
Activity Roster has been changed by your Manager.
Someone has left a comment in a Pod forum.
Someone has left a coaching comment.
Someone in a Pod has committed a new Annual Plan.
Someone in a Pod has committed their Monthly Calendaring.
My Manager has removed me from a Pod
My Manager has added me to a Pod
Someone has been removed from my Pod
Someone has been added to my Pod
A subordinate has completed their Daily Activity
To an Owned Agent—their owning Agent has set up their Monthly Calendar. This notification's text may include the suggestion that they send via email that they have received and reviewed their Monthly Calendar to their owning Agent.

The following are special notifications that can be configured to be sent at a particular time of the day. These emails may include the link to the site that is relevant page. The goal is for the user to keep the site open at all times so they can hit the “+” button. They cannot be included in a Daily Summary.
First Reminder that Daily Activities need to be Completed by an Agent or an Owned Agent—link to Agent Home Page that includes Daily Activity Entry.
Second Reminder that Daily Activities need to be Completed by an Agent or an Owned Agent
First Reminder to Agent who has Owned Agents who have not completed Daily Activities—link to the Agent Summary Report for Owned Agents
Second Reminder to Agent who has Owned Agents who have not completed Daily Activities
First Reminder to Managers to check Daily Activities when some have not been Completed. (Managers only)—link to the Agent Summary Report for All Agents
Second Reminder to Managers to check Daily Activities when some have not been Completed. (Managers only)

The system may default to having each of these set to send to the user at a default times (system wide). Users can change the time and turn off notifications that they do not wish to receive.

The owning Agent controls when their Owned Agents receive the reminder emails. For the Product this may be done once for all Owned Agents. They may not be able to set specific reminder times for individual Owned Agents.

We also have special notifications and prompts for the following notifications:
Monthly Calendaring
Weekly Review of Opportunities

Users may not be able to control these notifications. The system handles them automatically. Both of these result in a pop-up appearing to the user when they log into the system.

The Monthly Calendaring notification may begin to be sent on the 25th of the month. It may continue to be sent until the last day of the month or whenever the user has completed their Monthly Calendaring.

The Weekly Review of Opportunities may be sent on the last day of the week where there are planned Activities. This may include a link to the relevant page.

### 11. Administrator and System Functionality

The admin interface may be simple from a styling standpoint. It may be designed to be efficiently accessed. It may work on a limited set of browsers.

### 11.1. Administration Functions

### 11.1.1. Login

There may be a “PODs Administration” Login. Only a highly-restricted set of PODs Admins may be provided with a recognized user id and password. Unrecognized user ids and passwords may be denied access.

There may only be 1 category of site administrator initially. Administrators may have access to all of the following capabilities.

### 11.1.2. User Data

Administrators may be able to find users using simple field searches and may be able to view/edit user data.

Admins may be able to see transactions for that user and cancel the user's subscription.

### 11.1.3. Basic Usage Information

The main administration page may include basic information:
Number of Registered Users of each subscription type
Number logged on, subscribed Today and this Week

### 11.2. Web Analytics

Additional data may be available using Google Analytics. The system may integrate appropriate JavaScript code on each page that can track usage information on an aggregate level.

### 11.3. Auditing

The system may record the following in audit tables:
Changes done to user profiles, accounts
Subscription transactions
Date/time stamped values for completion of an Activity. In other words, each time the user clicks the + button an audit table item may be created.

Each row may include the logged in user information and the prior value and new value.

This may only store into the database, there is not interface to this information.

11.4. Custom “404” page

The web server may be configured to serve up a custom “page not found” page that fits with the graphic design of the site.

### 12. Technical Aspects

### 12.1. Browsers OS Support, Screen Resolution

Web interface resolution target: full-color 1024×768. Mobile interface resolution target: may use 480 width as target.

Browsers:
Internet Explorer® 8 and 9 on Windows XP®, Windows 7®
Firefox release channel on Windows XP®, Windows 7®, and Mac OSX®
Chrome® release channel on Windows XP®, Windows 7®, and Mac OSX®
Safari on Mac OSX®
Safari on iOS® (iPhone 3+® and iPad®)
Chrome on Android® (mainstream Android® device)
   13.

In one or more embodiments of PODs the following functionality is included.

### 13.1. Cross Sell Attempt

An embodiment may add a specific kind of action that occurs as part of an Opportunity: “Did you attempt to cross-sell?” The user would be able to indicate that “Yes, I tried to cross sell, but the prospect said no to getting a quote.” For the Product, we can somewhat tell based on the number of quotes per opportunity for the user.

### 13.2. Terminology Admin Editing

An embodiment may support change terminology via an admin interface.

### 13.3. Social Networking

An embodiment may include integration with social networks such as LinkedIn, Facebook, etc.

### 13.4. CRM Integration

An embodiment may have the ability to integrate with client specified CRM solutions.

### 13.5. Content Management

Administrators may be able to add, edit, delete content blocks across the PODs application.

### 13.6. Competition

An embodiment may include the ability to set up competitions between individual Agents and teams of Agents.

Here are some functional notes on competition:
Managers may initiate competitions, choose criteria which can be a Race—achieve a specific goal or a ranking result
Agents are invited by Managers and must accept
Managers and Agents can see current results

When the competition is complete, the system may store the final sort order and not allow it to change at that point.

### 13.7. Ratings, Badges

An embodiment may use a kind of Ratings and/or Badge system.

Ratings might be based on the following:
100-90% is 5 stars
90-80% is 4.5 stars
80-70% is 4 stars
70-60% is 3.5 stars
60-50% is 3 stars
50-40% is 2.5 stars
40-30% is 2 stars
30-20% is 1.5 stars
20-10% is 1 star
10-0% is 0.5 stars

Badges could be awarded for achieving particular benchmarks. For example:
5, 10, 25, 50, 100 day streaks—days in a row with 100% completion
Improved Converter—their conversions went up month-to-month
Cross Sell Crusher—number of quotes per opportunity sold is greater than 1.5 for a given month

These can be promoted out to other Agents in the system as well as be something they might mention via Twitter, Facebook, etc.

### 13.8. Tutorial

An embodiment may position a ‘welcome’ tutorial here, guiding the Agent through the steps to come and the functionality they may have, but alternatively—the process finishes by leaving them at ‘Agent-home.’

### 13.9. Search Functionality

An embodiment may extend the system to allow browsing Agents using additional criteria. They may appear in a form similar to Pods/Reports. However, they do not need to be under the same manager.

### 13.10. Bells and Thresholds

An embodiment may add a chime/bell sound that may occur whenever an Agent reaches a given milestone. This might be when the Agent completes an activity (or all activities on a line), creates an opportunity, closes a sale, completes a day.

An embodiment may also have a chime/bell when other users make a given milestone.

### 13.11. Rewards

An embodiment can allow managers to define rewards such as Starbucks gift cards based on milestones. This may be associated with competitions.\

### 13.12. Reply via Email

An embodiment may allow to replying to coaching and forum comments via a reply in email.

### 13.13. Time Values

An embodiment may use time values associated with Activities to help with Planning and Calendaring.

### 13.14. Content Search

An embodiment may implement searching of Notes, Opportunity Names, Comments in Forums or other text information.

### 13.15. Leads

An embodiment may have another level of conversion.

PODs is a web-based application which enables managers to prescribe, based on income goals or even business objectives, comprehensive activity plans for themselves and their staff (whether they be sales people, admin, or other). The completion of these activities is recorded by the individual in PODs. This is no different than other task management applications. When activities are completed, and completion is recorded in PODs, their progress against completion of said activity is represented immediately in pod view for all to see, including the manager and the other individuals in that pod.

Moreover, individuals can and should—as they record completions—use the Opportunities function to record the results of those activities. These results that are inputted are also displayed immediately for full viewing. This capturing of results provides a couple of key benefits for managers: 1) they may now draw conclusions about the quantity and quality of the activity of their subordinates. For example, if Tom is consistently completing a high percentage of his prescribed activities but his results are poor, then he's likely either fibbing about the actual activity level or he's in need of coaching to perform the activities more effectively; and 2) managers and business owners are now able to periodically analyze the results of their team's efforts, and very specifically point to the activities which garnered the best results, and those which didn't. This provides for the ability to make sound decisions with regard to resource allocation for both people and money; let's focus our time, money and effort on “these” activities which clearly move us toward our goal, and do less of “those” which appear to be time and money wasters.

While the invention has been disclosed in connection with certain preferred embodiments, other embodiments will be recognized by those of ordinary skill in the art, and all such variations, modifications, and substitutions are intended to fall within the scope of this disclosure. Thus, the inventions disclosed herein are to be understood with respect to the following claims, which should be interpreted in the broadest sense allowable by law:

What is claimed is:

1. A computer-readable medium having executable instructions that, when executed by a processing device, enable the processing device to perform a method comprising the steps of:
determining an user set comprising at least one user entity;
determining a manager set comprising at least one manager entity, the at least one manager entity corresponding to the user set;
determining an income goal in a predetermined time period for each said user entity of the set;
determining a set of tasks, each task in the set, when performed by an user entity of the set, being worth a corresponding respective percentage of the income goal of said performing user entity;
presenting a first user interface enabling an user entity of the set to input one or more descriptions of performance by the user entity of a task in the set; and
presenting a second user interface configured to graphically illustrate to the manager entity information describing at least one of task performance by user entities of the set and progress by each said user entity of the set toward the income goal of each said user entity of the set.
